(19) United States
(12) Patent Application Publication
(10) Pub. No.: US 2006/0171846 A1
(43) Pub. Date: Aug. 3, 2006

(54) Microfluidic systems incorporating integrated optical waveguides

(76) Inventors: David W. M. Marr, Golden, CO (US); Jeff Squier, Golden, CO (US)

Correspondence Address: SHERIDAN ROSS PC, 1560 BROADWAY, SUITE 1200, DENVER, CO, 80202, US

(21) Appl. No.: 11/329,491

(22) Filed: Jan. 10, 2006

Related U.S. Application Data
(60) Provisional application No. 60/642,817, filed on Jan. 10, 2005.

(51) Int. Cl. G01N 21/00

(52) U.S. Cl. 422/82.11

(57) ABSTRACT

The invention provides microfluidic systems incorporating optical waveguides integrated, which can be used to optically interrogate particulate such as cells flowing through the system. The waveguides within these systems may be arranged to form optical traps, which may be used to power pumps and valves in the microfluidic systems, to trap and interrogate particles within these systems, and to sort trapped particles into different channels of microfluidic flow.

### CROSS REFERENCE TO RELATED APPLICATION

This application claims priority under 35 U.S.C. § 119(e) to U.S. Provisional Patent Application Ser. No. 60/642,817 filed Jan. 10, 2005, which is incorporated herein, in its entirety, by this reference.

### GOVERNMENT INTEREST

This invention was made with Government support under grant number R21 EB001722-01 awarded by the National Institutes of Health (NIH). The Government has certain rights in this invention.

### FIELD OF THE INVENTION

The present invention is directed to microfluidic systems, and, more particularly, to optical waveguides integrated into microfluidic systems, which can be used to optically interrogate particulate such as cells flowing through the system. In addition, a specifically arranged array of waveguides may form optical traps which, when sequentially pulsed, may be used to power pumps and valves in the microfluidic systems and to sort trapped particles into different channels of microfluidic flow.

### BACKGROUND OF THE INVENTION

The use of microfluidics as a versatile and powerful research tool is becoming increasingly popular in diverse technological disciplines. Because of their size, microfluidic devices are able to both exploit unique transport properties and provide the capability for significant parallelization and high throughput. These qualities have led to successful applications in printing, surface patterning, genetic analysis, molecular separations, and sensors. The effective separation and manipulation of colloidal and cellular suspensions on the micro-scale has been pursued with increasing interest due to the desire to investigate the behavior of individual cells and particles within microfluidic devices. One such device is the subject of U.S. Pat. No. 6,802,489 entitled “Devices Employing Colloidal-Sized Particles” to Marr et al., and U.S. patent application Ser. No. 10/248,653 filed Feb. 4, 2003, entitled “Laminar Flow-Based Separations of Colloidal and Cellular Particles” to Marr et al., both of which are incorporated herein, in their entirety, by this reference.

The technology of macroscopic fluorescence activated cell sorters (FACS), while capable of efficient and high throughput separations, does not fill the need for microfluidic systems, as it cannot readily be rendered to the micro-scale. Therefore, electro-kinetically actuated microfluidic devices for the purpose of sorting and manipulating populations of cells in continuous microfluidic flows have been developed with promising results. To reduce the need for cumbersome detection and actuation hardware associated with the devices developed to date, it would be advantageous to have a microfluidic system capable of sorting and transporting such particles with a relatively simple feed and distribution network.

Additionally, because an enormous number of current biochemical assays rely on flourescent tagging, excitation, and detection, any novel scheme must successfully accommodate these methods. The use of fluorescence is a ubiquitous practice in microbiology and biochemistry as well as colloidal science, biophysics and a host of other disciplines. The power and convenience of labeling cells, cellular components or individual biomolecules with molecular or colloidal fluorescent probes has enabled the elucidation of countless cellular metabolic and bio-molecular assembly processes. Similarly, the fluorescence labeling of cells combined with traditional macroscopic FACS systems allows for the identification and separation of rare cells from concentrated suspensions, the sequestration of cells displaying desired physiological properties or metabolic states, and the parsing of large combinatorial libraries for specific information. In an acute demonstration of the ability to encode and decrypt vast databases of genomic information using only fluorescently dyed microspheres, a combinatorial library containing over four billion different DNA oligimers was generated and used to screen a solution of restriction fragments. While useful in this area, this technology is currently bound to FACS and fluorescence microscopes. Accordingly, it would be advantageous if such operations and features could be liberated into microfluidic environments where a portable optical platform was available that allowed for convenient fluorescent excitation of biological samples, signal acquisition, interpretation, and real time feed back.

### SUMMARY OF THE INVENTION

The present invention provides microfluidic systems incorporating optical trapping and sorting technologies at the microscopic scale to produce a portable optical microfluidic platform for trapping, interrogating and sorting microparticles including fluorescently-tagged biological molecules and structures. These microfluidic devices include separate microfluidic layers, waveguiding layers and a microstructure layer which is often a cover slip/PDMS layer. The microfluidics layer may include a number of working microfluidic devices including micron scale pumps and valves such as microchannel structures, positive displacement microfluidic pumps, check valve devices, three-way valves and the like.

The microfluidic system includes a light source, which may be a laser diode bar with an LCD modulator, a single, compact solid state laser diode, multiple laser diodes, and the like. The microfluidic system includes at least one microfluidic device, which includes a plurality of waveguides, which may be used for excitation and detection of particles within the microfluidic device. The microfluidic device may include a variety of microfluidic device structures, including microfluidic pumps and valves. The microfluidic devices use optical trapping to power pumps and valves, and enable performance of optical interrogation of particles and cells. The microfluidic system typically includes a detection portion which may be used in imaging and translation of particles within the microfluidic device. The detection portion may also be used to detect fluorescence emissions from particles that are illuminated with excitation waveguides. The system includes an input, which provides the particle or cell input into the microfluidic device. Additional inputs into the microfluidic device may include a fiber optic bundles, which communicate light from the light source into the microfluidic device and/or relay optical image information from particles within the microfluidic device to a detection portion. In one embodiment, the inputs to the fiber optic bundle are modulated in intensity by a liquid crystal display LCD array.

Current methods for manipulating micrometer-sized colloids and cells with optical trapping require rapid-scanning mirrors or the use of holographic array generators. But scanning laser optical trapping (SLOT) is restricted by the piezoelectric elements that translate the mirror and is therefore limited in scalability in applications such as microfluidics. Comparable methods that use holographic optical tweezers (HOTs) require an array of optical vortices, spinning a large number of particles to create fluid flow. Optical vortices are single beam optical gradient force traps created by focusing helical modes of light, and are limited by their great sensitivity to aberrations.

One embodiment of the current invention overcomes the scaling limitations of conventional scanning systems while avoiding alterations to the basic laser mode through the utilization of a diode laser bar for the rapid manipulation of multiple particles in the microfluidic systems. This technique allows the control of objects within a trap line created by the diode laser bar focused onto the sample. By using this technique in a microfluidic system incorporating this device, particles may be manipulated in static and flowing environments using a simple mask at the intermediate image plane. This simple one to one control scheme, as well as angling the beam with respect to the channel enables efficient particle and cell sorting at the micro scale. Through the use of diode laser bars, vast arrays of independently-controlled particles and cells can be maneuvered.

The complete integration of microparticle detection and sorting in the microfluidic systems is possible using the methods and devices of the present invention. These techniques rely on direct waveguide writing using ultra-fast laser pulses, which produce index of refraction changes within materials. Tightly focusing a femtosecond pulsed laser into a block of fused silica produces a material change that locally increases the index of refraction of the glass. By translating the focus through the glass, a line of higher refractive index surrounded by a lower index material—a waveguide—is created. The waveguide transports single or multi-mode beams of light with minimal loss. Utilizing waveguides in coordination with microfluidic channels, fluorescence is induced in particles above the individual output of the guide. Because the excitation light is localized at the output of the waveguide, only colloidal particles or cells occupying a position directly above the output spot will fluoresce. Placing a band pass or rejection band filter in front of a CCD camera enables the excitation wavelength to be blocked, while detecting the emission from a particle located at the waveguide output. In this way, distinct flashes of a specific wavelength are produced as individual fluorescent particles pass over the waveguide outputs. This technique provides a parameter with which to sort particles that is compatible with many standard, well-developed fluorescent-labeling protocols. A particle can be sorted into a desired output stream by positioning it with the diode laser bar and identifying its fluorescence characteristics at the release point for the output with the waveguide.

### BRIEF DESCRIPTION OF THE DRAWINGS

FIG. 1, shows a basic system schematic of a microfluidic system of the present invention capable of cell sorting and optical interrogation of individual cells.

FIG. 2, shows a schematic of one embodiment of the microfluidic device of the present invention in three separate layers including a microfluidic layer, a waveguiding layer and a cover slip/PDMS layer.

FIG. 3 shows a schematic diagram of a microchannel structure of the present invention that may be used for separations of laminar flow streams.

FIG. 4, shows a schematic of a positive displacement microfluidic pump that may be created and operated within the microfluidic systems of the present invention.

FIG. 5, shows a schematic of a microfluidic check valve device that may be created and operated within the microfluidic systems of the present invention.

FIG. 6, shows a schematic of a microfluidic three-way valve that may be created and operated within the microfluidic systems of the present invention.

FIG. 8, shows a schematic diagram of a basic diode laser bar trapping and imaging system of the present invention.

FIG. 9, is a schematic diagram of a razorblade mask mounted within a translation stage depicting the restriction that may be placed on the path of the diode laser bar.

FIG. 10, shows the movement of a microparticle within a microfluidic system using the optical trapping methodology of the present invention.

FIG. 11, shows the progress of microparticles flowing through a microfluidic system of the present invention and being caught in an optical trap (vertical black line) defined by a diode laser bar projected into a microfluidic channel.

FIG. 12, presents a numeric simulation of the streamlines and relative flow rates within a 7-channel microfluidic sorting system

FIG. 13, is a schematic diagram of a microfluidic sorting system including optical waveguide integration and diode laser bar trapping.

FIG. 14, is a long-exposure photomicrograph of tracer particles flowing in streamlines within a microfluidic system of the present invention. White line indicates a 10 μm diode laser bar trap location. The two outside channels are waste and the middle two channels receive fluorescing and non-fluorescing sorted particles.

### DETAILED DESCRIPTION OF THE INVENTION

The present invention is drawn to microfluidic systems that manipulate, isolate and sort particulate such as colloidal particles, cells, cell organelles and the like, in a portable micro-scale platform that allows for trapping, manipulation, isolation and sorting of the particulate, with convenient signal acquisition, interpretation, and real time feedback and to methods of manufacturing and using these systems.

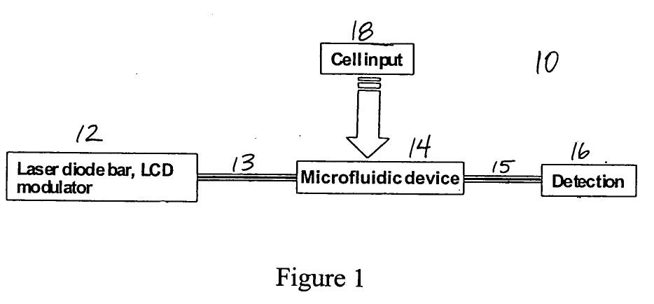

Referring to FIG. 1, a basic system schematic of a microfluidic system 10 capable of cell sorting, and optical interrogation of individual cells, is illustrated. The microfluidic system 10 includes a light source 12, which, in one preferred embodiment, is a laser diode bar with an LCD modulator. The light source 12 may include a single, compact solid state laser diode, which, in one embodiment, is a one watt diode. However, as will be understood, the light source 12 may include other devices, including multiple laser diodes, having various power consumption. The microfluidic system 10 includes at least one microfluidic device 14, which includes one or more lines of higher refractive index surrounded by a lower index material—optical waveguides—which may be used for excitation and detection of particles within the microfluidic device. The microfluidic device 14 may include a variety of microfluidic device structures, including microfluidic pumps and valves. The microfluidic devices use optical trapping to power pumps and valves, and enable performance of optical interrogation of particles and cells. The microfluidic system 10 generally includes a detection portion 16 which may be used in three-dimensional imaging of particles within the microfluidic device 14. The detection portion 16 may also be used to detect fluorescence emissions from particles that are illuminated with excitation waveguides. The system 10 also includes a cell input 18, which provides the particle input and cell input into the microfluidic device 14. The inputs into the microfluidic device 14 include a fiber optic bundle 13, which communicates light from the light source 12 into the microfluidic device 14. The system 10 also includes fiber optic bundles 15, which relay optical image information from particles within the microfluidic device to the detection portion 16. In one embodiment, the inputs to the fiber optic bundle 13 are modulated in intensity by a liquid crystal display LCD array.

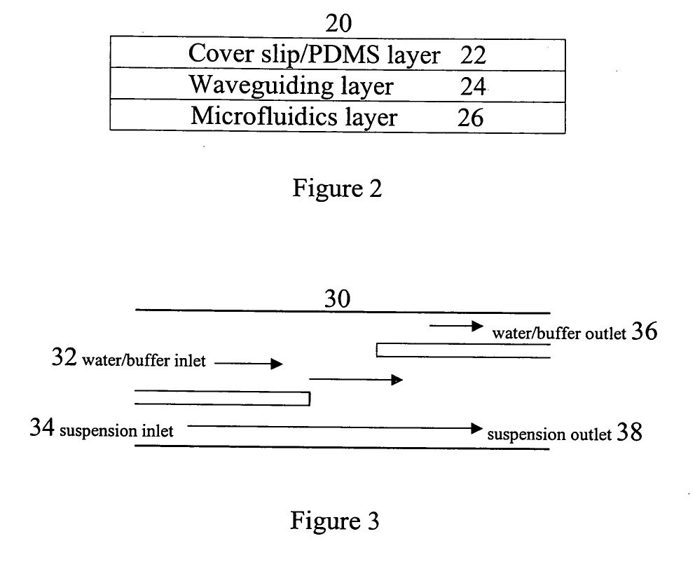

With reference now to FIG. 2, the microfluidic device 20 will be described in more detail. The microfluidic device 20 includes, in this embodiment, three separate layers including a microfluidic layer 26, a waveguiding layer 24 and a cover slip/PDMS layer 22. The microfluidics layer 26 may include a number of working microfluidic devices including micron scale pumps and valves.

In one embodiment, the microfluidics layer 26 includes large arrays of pumps and valves which can be independently operated, and operated in parallel, using optical traps which use the forces generated on an object near the focus of a laser beam to hold the object. Such traps have been used in a variety of applications from the study of molecular proteins to orienting and rotating microscopic particles, as described in U.S. Pat. No. 6,802,489 and U.S. patent application Ser. No. 10/248,653 filed Feb. 4, 2003, described above and incorporated herein. In one embodiment, the microfluidics layer 26 is used to sort particles and cells using separation maintained by microfluidic flows. This method of separating particulate suspensions employs the inherent laminar nature of microscale fluid dynamics and incorporates applied fields and image cytometry to enable sorting based upon any visually identifiable differences between colloidal-sized cells or particles, including traditional means such as fluorescence. However, this method does not require prior preparation with dyes, labels or tags. Accordingly, particles are easily isolated, separated, and sorted to enrich virtually any suspension of microscale biological or colloidal particles within a microfluidic system.

In one embodiment, the entire footprint of the device illustrated in FIG. 2 is less than 0.01 mm², allowing it to be parallelized for high throughput or readily incorporated within highly integrated micro total analysis systems (μTAS).

As described above, the microfluidics layer 26 relies on the laminar aqueous microfluidic streams for manipulation of cells and particles. Optical trapping techniques are employed for which the principle advantage is the highly selective manner in which the separation is performed, allowing only those cells or particles identified for separation (by microscopy combined with image analysis) to be trapped and transported at various angles away from the laminar flow and into a collection stream. Optical trapping eliminates the need for physical coupling between microchip-bound flow channels and the macroscopic world, as required by many previously proposed microfluidics techniques.

A schematic diagram of a microchannel structure used for separations of laminar flow streams is now described with reference to FIG. 3. The microchannel structure 30 includes a water/buffer inlet 32 and a suspension inlet 34. The water/buffer inlet 32, in one embodiment transports a clean buffer solution into the microchannel structure 30, and the suspension inlet 34 transports a suspension stream into the microchannel structure. The suspension inlet is examined for objects such as microparticles, cells or cellular organelles possessing desirable properties. For example, a simple trait may be assessed, such as a fluorescent signal, and particles/cells may be inspected for the presence of a fluorescent signal as they flow through the system. The examination is done by providing an excitation light to the particle/cell through a waveguide in the waveguiding layer, and receiving a detection signal through a detection waveguide in the waveguiding layer. The detection signal is then analyzed for the presence of desired trait(s). If the particles are moving too quickly to be observed for more complex characteristics, they may be immobilized by an optical trap and examined over longer time periods.

Once a target has been identified for separation, the optical trap is used to translate it into the collection stream where it is released. The collection stream in the embodiment of FIG. 3 is a water/buffer outlet 36, which splits away from the combined solution stream before reaching the suspension outlet 38, and carries no particles other than those selected and translated from the suspension using the optical trap. Because the maximum distance that the particle must be translated is the width of the suspension inlet stream 34, a single particle may be separated very quickly. Limitations to the efficiency of this separation technique lie primarily in the rate at which particles may be analyzed and the speed at which optical traps may be generated. In one embodiment, multiple optical waveguides are provided to the microfluidic stream, which provide for multiple optical traps, which may be operated in parallel, increasing the rate of separations and allowing for the identification and separation of different particles from the suspension.

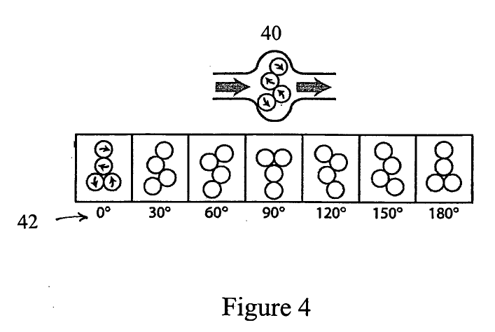

Referring now to FIG. 4, another microfluidic device, which may be present in the microfluidics layer 26, is described. The microfluidic device of FIG. 4 is a positive displacement microfluidic pump 40, which is created using colloidal particles that are translated with optical traps. In the embodiment of FIG. 4, a two-lobe gear pump in which small, trapped pockets of fluid are directed to a cavity fabricated in a microchannel by rotating two colloidal dumbbells or lobes in opposite directions. The rotation of the lobes is illustrated for several different degrees of displacement at 42. Over repeated rapid rotations, the accumulated effect of displacing these fluid pockets is sufficient to induce a net flow. This motion is illustrated in the clockwise rotation of the top lobe combined with the counterclockwise rotation of the bottom lobe, which induces flow from left to right in the various stages of rotation as illustrated at 42. To actuate the pump, waveguides provided at various locations transmit light in a manner such that a time-averaged pattern of four independent optical traps is created, one for each microsphere comprising the two lobe pump. By rotating the two traps in the upper part of the channel and the two traps in the lower part of the channel in opposite directions, and offset by 90°, the overall pump, and the corresponding fluid movement is achieved. Flow direction may be easily and quickly reversed by changing the rotation direction of both top and bottom lobes.

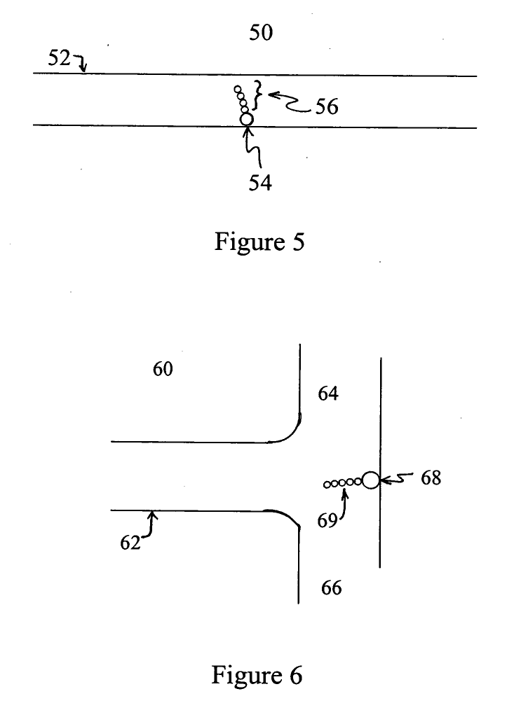

Referring now to FIG. 5, another microfluidic device which may be included in the microfluidics layer 26 is now described. In this embodiment, a check valve device 50 is arranged in a channel 52 and is comprised of a three micron silica sphere 178 polymerized to the end of a number of 0.64 micron silica colloids 56. The silica sphere 178 is held next to the wall of channel 52, allowing the remaining silica colloids 56 to rotate freely in the channel 52. The length of the entire check valve structure 50, in one embodiment, is approximately 15 microns, corresponding to the channel width and allowing a rotation of approximately 45°. At 45°, the valve is operable to interrupt the transport of colloids across the entire channel width while allowing unobstructed fluid flow. In one embodiment, a fluid flow in a first direction will push the valve arm 56 against the wall of channel 52, allowing particles flowing in the suspension within channel 52 to pass. A fluid flow in the other direction results in the valve arm 56 swinging across the channel 52, restricting the flow of larger particles within the channel. In one embodiment, the valve 50 restricts the flow of three micron particles while allowing particles of approximately 1.5 microns and smaller to pass through. Thus, the valve 50 selectively restricts the flow of large particles during back flow, allowing the passage of all spheres during forward flow. The small size and maneuverability of this valve design also allow for arbitrary placement or repositioning of the valve 50 throughout the entire channel network. In one embodiment, the valve 50 is actuated by optical trapping, with light source for the optical tapping provided by the waveguiding layer 24.

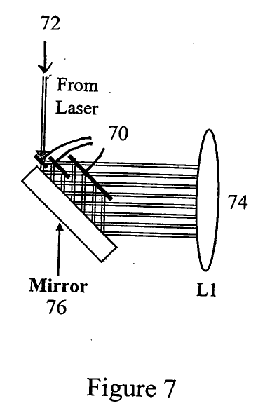

Referring now to FIG. 6, still another microfluidic device that may be contained in a microfluidics layer 26 is now described. As illustrated, the device in FIG. 6 is a three-way valve 60. The valve 60 may actively direct particulates into one of two exit channels (64, 66). The structure has an input channel 194, an upper exit channel 64, and a lower exit channel 66. The valve consists of a swivel point 68, which is, in one embodiment, a 3 micron silica sphere, and valve arm 69 having a number of 0.64 micron silica colloids. As the valve arm 69 is rotated about its swivel point 68, particles in a suspension entering through input channel 194 may be directed into either the upper exit channel 64 or the lower exit channel 66. The valve arm 69 is positioned using optical trapping techniques, with the light for such optical trapping provided by the waveguiding layer 54.

The use of optical trapping requires the use of transparent devices, which, in one embodiment, are fabricated in poly(dimethylsiloxine) (PDMS) using soft lithography techniques. PDMS provides a materials platform for device construction that is both transparent and bio-compatible, as well as inexpensive and quickly replicated. Microfluidic networks are created by transferring a pattern of a shadow mask to a negative photoresist film spun upon a silicon wafer to depths ranging from sub-micron to approximately 150 microns. A two-part mixture of PDMS is then poured and cured upon the silicon master to produce a flexible, bio-compatible, optically transparent replica. Because PDMS forms a tight seal with glass, no additional bonding or clamping is required to create a final microfluidic cell. One embodiment of the present invention uses several different PDMS layers to create three-dimensional microfluidic structures.

The waveguiding layer 24, in one embodiment, is fabricated using micro-machining techniques with femtosecond optical pulses from a femtosecond laser. Femtosecond lasers allow different dynamics of material removal, because of variable pulse length of the laser, going from melt expulsion for microsecond or nanosecond pulses, to vaporization or sublimation for femtosecond pulses. These dynamic differences produce concrete differences in the results obtained during laser machining of surfaces. Machining with femtosecond laser pulses generally reduces the amount of debris and surface contamination compared to that produced by longer pulses, a feature that is partially responsible for making femtosecond lasers the preferred tools for preparing photolithographic masks.

In one embodiment of the present invention, femtosecond laser pulses are utilized for micro-machining inside transparent materials. A femtosecond pulse is focused inside the bulk of a transparent material, resulting in the intensity in the focal volume becoming high enough to cause absorption through non-linear processes, leading to optical breakdown in the material. Because the absorption is strongly non-linear, this breakdown is localized to only the regions of highest radiance in the focal volume without affecting the surface. The energy deposited in the bulk material then produces permanent structural changes in the sample, which is used to micro-machine three dimensional structures inside the bulk material.

Moreover, the threshold nature of a femtosecond pulse interacting with a material allows ultra-short pulse machining with feature sizes below the diffraction limit. Accordingly, in one embodiment, the microfluidics layer and the waveguiding layer are fabricated using a femtosecond laser. In this embodiment, the bulk material surrounding the microfluidic channels are conditioned by inducing a refractive index change using the femtosecond beam to create any number of optical waveguides that terminate directly in the channels. In this embodiment, a multiple point machine is used to fabricate different structures.

An inherent deficiency limitation occurs when femtosecond lasers are used to machine precision structures. That limitation is below threshold for extreme change to the material that exists when high numerical aperture (NA) objectives are used to obtain a small feature size. A single sub-100 femtosecond pulse focused at a 1.4 NA with 5 nJ of energy can produce a peak power of 1.5 MW. This is sufficient to machine inside Corning 0211 glass, or other comparable materials. Increasing the peak power does not write more quickly, but instead produces voids and other undesirable features in the material being machined. Accordingly, only a fraction of the available pulse energy is generally used for machining, with the remaining energy wasted instead of being used to increase the machining rate. This means that only a small fraction of the light available from a typical commercial laser system may be used in traditional devices.

This limitation may be overcome by allowing limited resolution and feature size using an array of foci of the femtosecond laser. In this embodiment of the present invention, temporal decorrelation is used to eliminate any interference between the foci in a multi-focal array. This method relies on producing a foci in which the pulse arrival time at each focus differs by at least the pulse duration. Since the pulses do not overlap temporally, the foci do not interfere, even if they overlap spatially. With this interference eliminated, the foci may be placed arbitrarily close together without degradation of the focal characteristics, which would be present if multiple foci were attempted in a planar area, which would result in the foci interfering with each other and reduce the efficiency and accuracy of the structure being produced. This multi-focal approach enables fabrication of multiple channels simultaneously. This is accomplished, in one embodiment, using cascaded beam splitters to build temporally decorrelated multi-focal microscopes.

FIG. 7 illustrates a multi-focal beam splitting microscope of one embodiment of the present invention. Several multi-focal beam splitters 70 receive laser light 72 transmitting a portion of the light to a mirror 76 and a portion of the light to a lens 74. The lens 74 is the input to an imaging system that relays all the beams to the microscope in a manner such that the full NA of the microscope is maintained for all beams. This design allows for 100% of light from the laser to be used, resulting in arrays of up to 32 foci. With this design, diffraction-limited sectioning is achieved, with beams spaced as close as 2 μm apart at the microscope focal plane. At high laser power, each of these beams can be used to machine, while at low intensities, each beam can be used to optically interrogate or image the structure. By allowing both machining, and optical interrogation or imaging, the embodiment illustrated in FIG. 7 provides for the monitoring of the quality of the machining as it occurs, and for post-machining detection of the structures as well. These diagnostics allow for quantitative real-time monitoring of the micromachining process, which increases yield for the micro-machining process.

The micromachining laser, in one embodiment, is a chirped pulse amplification system that operates at 3 to 50 kHz. Intrinsic to the system is a low level, 100 megahertz train of broadband (80 nm) pulses that travel collinear with the amplified kilohertz pulses. This lower level train is used to perform spectral interferometry. By interfering the reflected pulse train with a reference pulse train, monitoring of important characteristics of the machining process, such as cutting rate, refractive index changes, etc., may be achieved. The fringing pattern produced by two pulses as they interfere in the spectrometer is used to extract information such as the cutting rate, the fringe spacing being directly related to the relative spacing in time of the two pulses. This monitoring may be done with relatively weak signals using detectors, with no moving parts. Absolute depth measurements are limited by the bandwidth of the probe pulse and the presence of noise. For instance, a 15 fs pulse will limit the axial resolution to about 1.5 micron, the coherence length of the pulse. However, relative depth measurements may be made with an order of magnitude better precision. A 1 pJ pulse may be used to probe the sample, and backscattered light is collected from the sample within efficiency of 10⁻⁵. The pulse spectrum may be measured with a signal to noise ratio of 140 to 1 in less than a millisecond, resulting in the appropriate measurement. This is sufficient signal-to-noise to make relative comparison of successive pulse spectra. Depth changes as small as 30 nm may be detected between successive shots. This provides a real time method for accurate measurements of cutting rates, making it possible to rapidly micro-machine profiles with sub-micron precision. This also makes it possible to measure such characteristics as ablation threshold (or other laser-induced material modifications) in real time.

In one embodiment, third harmonic generation (THG) is used to monitor and evaluate the machining of the laser. THG is the instantaneous conversion of three photons from the fundamental laser beam to a single photon at the third harmonic frequency. The third harmonic generation is generally allowed in any material, since odd powered non-linear susceptibilities are non-vanishing in all materials. Due to the Gouy phase shift of π radians that the fundamental beam experiences when passing through focus, however, only negative wavevector mismatch compensates for the shifting phase and allows the THG to be produced efficiently. Thus, THG is absent for ΔK=3K_{L}−K_{THG}=0, where K_{L} is the wavevector of the fundamental and K_{THG} is the wavevector of the third harmonic. In other words, there is no THG for a negative wave vector mismatch, which is the case for media with normal dispersion, (i.e., where the refractive index decreases as a function of wavelength). If, however, there are inhomogeneities near the focal point, a third-harmonic is generated. This is especially the case for interfaces in refractive index or third-order non-linear susceptibility. Note that THG is not restricted to the surface of the material only, but rather, results from the bulk of material contained within the focal volume in the presence of interfaces or inhomogeneities therein.

Accordingly, THG imaging has a number of distinctive characteristics. For example, under tight focusing conditions, efficient generation of a third harmonic occurs only near interfaces or inhomogeneities in refractive index and/or third-order non-linear susceptibility. Thus, THG imaging requires no exogenous labeling and can discern at the interface between two media based on a difference in non-linear susceptibility, or refractive index alone. The generation of third harmonic is restricted to the focal region. In particular, the full-width-at-half-maximum of the axial response of a THG microscope to an interference between two media is equal to the confocal perimeter at the fundamental wavelength. This property enables three-dimensional imaging.

THG is a coherent phenomenon in which the third-harmonic radiation is generated in the forward direction. For a linearly-polarized input laser beam, the generative third-harmonic is also linearly polarized in the same direction. The third-order power dependence of the THG on the input laser power results in an inverse square dependence on the laser pulse width. Typical conversion efficiencies from the fundamental to third-harmonic are in the range of 10⁻⁷ through 10⁻⁹ and conversion efficiencies up to 10⁻⁵ have been reported for specific materials. THG imaging is a transmission mode microscopy, similar to phase contrast microscopy, but with inherent three-dimensionally sectioning properties. Thus, whereas phase contrast microscopy depends on accumulated phase differences along the optical path length, THG microscopy is sensitive to differences in physical properties localized within the focal volume. The noninvasive character of THG imaging has been demonstrated in various applications of microscopic imaging of biological specimens. In addition, fading of contrast, equivalent to the bleaching of fluorescence, is absent in THG imaging applications.

These characteristics allow THG imaging to be used for monitoring the micromachining process. THG production occurs as soon as the physical properties of the material change. This immediate change means that THG production can be used to detect a change in the material properties of the sample during machining. THG imaging can also be used for post detection as well. The THG imaging makes it possible to take an image through an interface and measure the absolute value of the index change, as well as the change in non-linear susceptibility. This illustrates how THG imaging may be used as a quantitative imaging tool in micromachining. It can be used to measure when a permanent change in the material has occurred. The spacial extent of this change, and the degree of the material modification as measured by the index in refractive index may also be measured.

The waveguiding layer, combined with the microfluidics layer, allow for massively parallel microfluidic devices in the microfluidic layers, which may be simultaneously controlled by waveguiding layer. The cover slip/PDMS layer covers each of the waveguiding and microfluidics layer, and provides additional protection to the waveguiding and microfluidics layer.

One embodiment of the present invention is a technique for trapping, sorting, and manipulating cells and micrometer-sized particles within microfluidic systems, using a diode laser bar. This technique overcomes the scaling limitations of conventional scanned laser traps, while avoiding the computational and optical complexity inherent to holographic optical trapping schemes. The diode laser bar provides control over a large trapping zone, defined by the dimensions of the diode laser bar, without the necessity of scanning or altering the phase of the beam. In a preferred embodiment, the dimensions of the trapping zone are 1 μm by 100 μm.

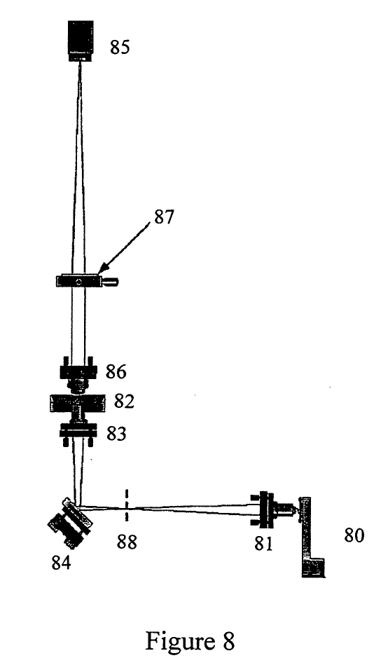

Referring to FIG. 8, a basic diode laser bar trapping system of the present invention is described. The output of a diode laser bar emitter 80 is imaged by a numerical aperture (NA) objective 81. This image is relayed into the sample 82 by a second, identical objective (the delivery objective) 83, consequently preserving the original dimensions of the diode laser bar. A 45-degree high reflector mirror (HR at 1064 nm) 84 is located between the two objectives (81 and 83) and serves to couple white light into the system from a fiber lamp. This white light source is used to simultaneously view the sample and align the optical trap. A CCD camera 85 may be used to align and image the diode laser bar within the sample, which may constitute a microfluidic system. An infinity corrected objective 86 (imaging objective) is located between the sample 82 and the camera 85. An optional filter 87 may be placed between the imaging objective 86 and the camera 85. In a preferred embodiment, the diode laser bar emitter 80 is a UNIPHASE™, SDL-6300), capable of producing 3 W of average power, is 100 μm by 1 μm centered at a wavelength of 980 nm, the objectives (81 and 83) are 10×0.25 NA objectives and the imaging objective (86) is a 40×, 0.65 NA objective.

Stationary trapping of multiple objects is possible by imaging of the diode laser bar on the sample. Many colloids and cells may be trapped simultaneously along the entire length of the trap zone, corresponding to the length of the laser line focused on the sample.

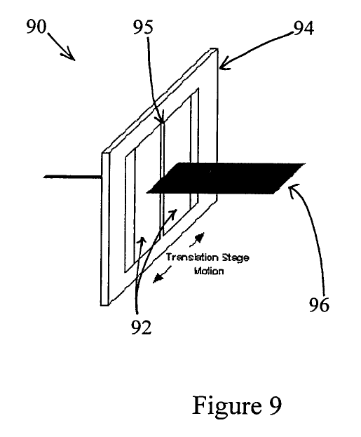

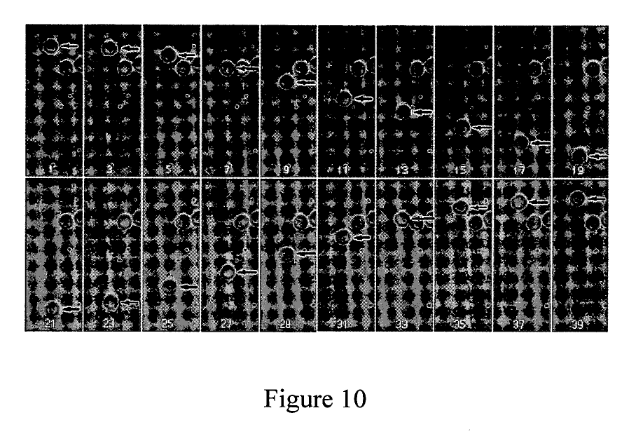

Referring again to FIG. 8, an optional transmission mask 88 may be inserted at the intermediate image plane between the two objectives (81 and 83). The mask is used to move particles within the trap zone. This mask is preferably adjustable to vary the length of the diode laser bar thereby shortening or extending the length of the trap zone. Particles in the sample can be trapped at any point along the length of the trap by simply sliding the mask through this intermediate image plane. In one embodiment shown in FIG. 9, the mask 90 consists of two razorblades 92 mounted on a 1-D translation stage 94 with an adjustable gap 95 between the edges of the razorblades 92. The stage moves perpendicular to the path of the beam 96, and the razorblades 92 obstruct the beam 96, while the gap 95 between the razorblades 92, allows only a fraction of the beam 96 to pass through to the sample. An example of the microparticle manipulation possible using this system is demonstrated in FIG. 10 which shows the manual translation of a single 10 μm polystyrene colloidal particle through the entire length of the trap defined by the projection of the diode line bar on the sample and back to the starting position by movement of the translation stage back and forth through the beam from the diode bar laser.

This system also permits the trapping and manipulation of microscopic objects within the flow in a microfluidic channel thereby permitting sorting of particles within a microfluidic sample. As described above, microfluidic networks can be fabricated in polydimethylsiloxane (PDMS) using soft-lithography. This method enables microfluidic networks to be quickly replicated from a permanent, reusable master with fidelity on the order of single nanometers and a feature size less than 100 nm. The networks are created by first transferring the pattern of a shadow mask to a negative photoresist film spun upon a silicon wafer to a depth of approximately 20 μm. For example, a two-part mixture of PDMS can be poured and cured upon a silicon master to produce an optically-transparent replica, and a glass coverslip is bonded to the PDMS channel network by a brief exposure to oxygen plasma, producing an irreversible seal.

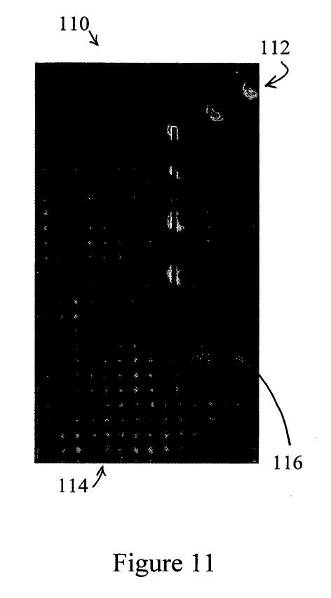

A microfluidic system fabricated by this method is shown in FIG. 11. The microfluidic system can be charged with a suspension of colloidal particles 112 flowing freely through the channel 114 until they become trapped in the laser trap line 116 created by the diode laser bar. Since the laser trap line 116 is oriented at an angle with respect to the direction of flow of the suspension through the channel 114, the particles move like an optical conveyor belt entering at one part of the trap line 116, flowing down the trap line 116, and being released at the end of the trap line 116. A gradient in the fluid velocity profile pushes the colloidal particles 112 along the entire length of the trap line 116, until finally driving them out at the end. Similar to the manipulation of particles within a static system described above, it is possible to actively manipulate objects within a flowing environment by incorporating a mask located at the intermediate image plane. Using such a mask, it is possible to trap a single colloidal particle or cell and move it along the length of the trapping zone as other particles flow by in a microfluidic channel. This demonstrates that one-to-one amplitude masks make it possible to manipulate trapped objects over large distances in a straightforward manner using microfluidic systems incorporating optical waveguides of the present invention.

In addition to manipulating multiple or individual microparticles, the microfluidic systems incorporating diode laser bars can be used to sort microparticles flowing through a microfluidic network. The diode laser bar trap focused on a microfluidic channel having microparticles flowing through it will trap multiple particles leaving a path clear of the microparticles in the channel down stream of the trap. Notably, this is the first optical sorting technique used for cells that does not require scanning or altering the phase or amplitude of the trapping beam in any way.

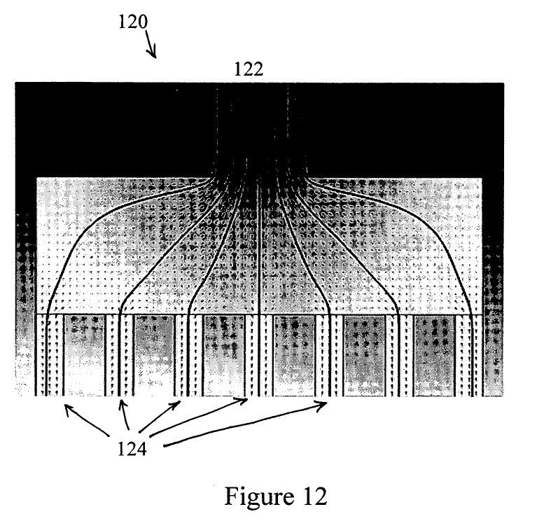

Additionally, aliquots of microparticles can be released by blocking the diode laser beam. For example, referring to FIG. 12, in a microfluidic system 120 which contains many output channels 124 flowing from one microfluidic input channel 122, when the diode laser bar trap is focused on the microfluidic input channel 122, the microparticles may be trapped, translated, and released into the desired region of the system. Individual particles may then be directed to a specific destination by allowing the beam to translate a microparticle to a specific point in the microfluidic input channel 122, and then blocking the diode laser bar beam, releasing the microparticle from the trap, allowing laminar flow and slow diffusion to keep the microparticle in the same streamline which determines which outlet channel 124 the microparticle will enter.

This embodiment provides methods and devices to trap, manipulate, and sort a variety of microscopic objects that vary in size and refractive index within a microfluidic system using a diode laser bar. The movement and trapping of these objects is controlled in both stationary and flowing environments and objects can be positioned into targeted streamlines by angling the trap with respect to the channel and blocking/unblocking different sections of the beam. Transmission of the trap may, in all instances, be controlled by a simple amplitude mask. This new laser trapping technique is significant in that it addresses design issues that presently prohibit the development of truly practical, economical, optically-actuated microfluidic cell sorters and analyzers. Additionally, because only a fraction of the available laser power is used, a single diode laser bar can be multiplexed and used to simultaneously drive flow and manipulate objects over a vast array of channels. Manipulative tasks within the microfluidic system are clearly a straightforward process using this laser diode geometry. For many of these tasks, scanning can be entirely eliminated, and no complex holographic processes to reshape and control the beam location are required.

While integrated diode laser bar optical trapping with monolithic waveguides reduces the fabrication and process control complexity associated with microfluidic cell sorters, this methodology also represents a significant step toward complete process integration by producing a novel method for sorting fluorescent cells and particles on the basis of their optical signature within the microfluidic systems.

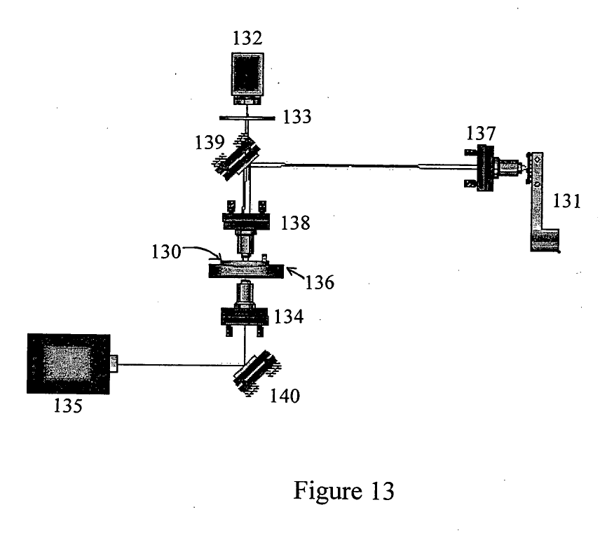

Individual particles can be manipulated by focusing and aligning a diode laser bar, centered at a wavelength of 980 nm, within a microfluidic channel. The laser output is relayed one-to-one into the sample to create an identical image of the diode bar and thus a trap is formed within the microchannel as described above. The microchannel and contents are imaged with a camera that may be connected to a monitor and camcorder to capture the images. A schematic of the complete optical train is depicted in FIG. 13. Microparticles tagged or dyed with at least one distinct fluorescent dye are charged to the microfluidic device 130. At least one excitation laser 131 of appropriate wavelength is utilized. A signal sensor 132 (such as a photodiode or CCD camera) with an optical filter 133 captures the fluorescence signal, and a shutter, such as the razorblade shutter described above, can be used to block the trapping beam for particle release. The signal sensor 132 and shutter are controlled using computer feedback.

For sorting microparticles within the microfluidics systems with conventional optics, non-waveguided excitation light is focused on the sample with a microscope objective 134. For sorting experiments with integrated waveguiding, at least one excitation laser 135 is coupled directly into an optical waveguide 136. A single input beam is split into 4 output beams of nearly equal intensity. The output of a diode laser bar emitter 131 is imaged by a numerical aperture (NA) objective 137 and the image is relayed into the microfluidic device 130 by a second, identical objective (the delivery objective) 138, consequently preserving the original dimensions of the diode laser bar. A 45-degree high reflector mirror 139 is located between the two objectives (137 and 138) and may serve to couple white light into the system from a fiber lamp. Similarly, a 45-degree mirror 140 may be located between the excitation laser(s) 135 and the microscope objective 134.

In a preferred embodiment, the output beams are spaced 30 μm apart, and the circular mode waveguides are machined into a 50.8 mm by 25.4 mm by 12.7 mm block of fused silica using femtosecond pulses. The resulting index of refraction change in this embodiment is approximately 6×10⁻³, with an estimated emission NA of 0.15.

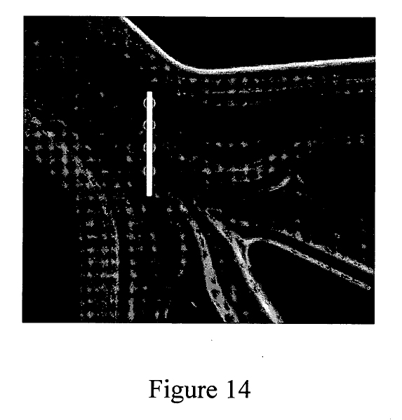

As described above, microfluidic channel networks may be created in poly(dimethylsiloxane) (PDMS), using well established soft lithography techniques. The dimensions and orientation of both the trapping beam and hydrodynamic focusing network used to align the sample particles into a streamline that intersects the edge of the trapping region can be seen in FIG. 14. In this long-exposure micrograph, striated streamlines traced by fluorescent particles are clearly seen. The sample particles, cells or colloids, are delivered from an upstream channel and focused into a continuous line of particles illustrated by the dark streamline in FIG. 14. The particles then intersect the line trap (illustrated by the white line in the micrograph) and are pushed by the flow, across the channel.

Focusing the diode laser bar within the microfluidic channel and orienting the resulting trap line at an angle with respect to the direction of flow forms a cell sorter within the microfluidic system. The end of the trap line is aligned so that it protrudes into the sample streamline. This configuration serves to modify a trapped particle's axial motion by introducing a force perpendicular to the streamline. The particles encountering the trap are therefore translated along the trap line as if they were in an optical conveyor belt. As described above, particles enter at one end of the trap, flow down the line, and are released as they reach the downstream terminus. To release the particles before they reach the end of the trap, all or part of the laser bar beam may be temporarily blocked, sending the particles into any given streamline along the length of the trap.

To introduce particle sorting on the basis of fluorescence, an external laser 135 is also focused within the microfluidic channel. By aligning the trap line with the path of the excitation laser, particles will express their fluorescent signal at a single location as they pass through the focus of the excitation beam while being translated along the trap line. By combining this knowledge of the fluorescent properties of the particles with the precise streamline that the particle is in, a level of control is attained that can be exploited for sorting. A simple feedback mechanism converts the measured emission flash into a command to shutter the beam, releasing the particle from the trap.

Using these techniques, a mixture of labeled and unlabeled microparticles in a microfluidic system can be sorted based strictly on their fluorescence signal. When a fluorescent particle enters the trap and fluoresces, the particle's position is monitored by optical microscopy as it continues its path along the trap until it has reached the designated separation streamline. The diode laser bar beam is then shuttered, releasing the particle into the desired output stream. Thus, a single fluorescent colloid may be picked out from a group of non-fluorescent colloids and sent to a specific output channel.

This technique functions for sorting at a single point with a single wavelength, but alternate techniques can be scaled to a larger and more diverse number of particles. Accommodating and controlling selective multiparametric distributions of particles throughout the microfluidic networks demands the ability to both identify multiple fluorescent labels and automatically track particle position. Both of these features are accomplished by integrating optical waveguiding networks into the sorting scheme.

The waveguides have the unique ability to accept a single input beam and split it to an arbitrary number of outputs with little loss. This multifunctional beam splitting and waveguiding capability may be used to track the position of particles while simultaneously multiplexing the excitation radiation for sorting into multiple, parallel channels. Because the waveguides are only a few micrometers in diameter, and may be spaced to within as few as two diameters without crosstalk, multiparametric sorting is potentially possible with several individual waveguides, each transporting a distinct wavelength. Combining multiplexed waveguides with the diode laser bar's ability to trap over a large linear distance, and thus a large number of streamlines, overcomes the scaling limitations of conventional beam steering optics. To integrate waveguiding and trapping, the diode laser bar trap is aligned over at least two, and preferably four or more, waveguide outputs, ensuring that fluorescence emitted by trapped particles will be localized over individual waveguides. Thus, the sorting of particles displaying distinct optical characteristics is enabled by diode bar optical trapping in conjunction with integrated waveguide-coupled excitation light.

This integrated approach to microfluidic sorting based on fluorescence streamlines sorting feedback and control, and therefore increases the throughput potential of optically actuated platforms. Higher sorting rates may be obtained through a number of routes, including beam splitting for parallel processing, multi-wavelength analysis and independent control over portions of the beam. The distance that a particle can be translated is related to the angle of the trap by D=L·Cos(θ), where D is the lateral distance a particle can be translated and L is length of the trap. Thus, to sort efficiently in fast flow environments, fewer waveguide outputs may be placed within the trapping zone. A compromise must therefore be made between the number of sorting parameters and the speed at which a particle can be trapped. To overcome this limitation to high throughput multiparametric sorting, the the trapping and excitation beams are multiplexed. Because only a fraction of the available diode bar laser power (the optical trapping laser) is used, a single diode laser bar could be split to manipulate objects over a vast array of channels. Utilizing waveguides rather than focused light sources allows localization and multiplexing of the excitation for fluorescence. Thus, using a single input to multiple output waveguides, single wavelength excitation sources can be transported to any number of trapping areas enabling the sorting of particles or cells simultaneously within many trap lines. Manipulative tasks within the microfluidic system are a straightforward process using this integrated laser diode and waveguide geometry.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A microfluidic structure adapted for isolating at least one particle, comprising:
a channel operable to contain a microfluidic stream;
at least one particle located in the channel;
at least one optical waveguide positioned substantially adjacent to the channel and operable to optically trap the at least one particle in the channel, thereby manipulating the microfluidic stream and isolating the at least one particle.

2. The microfluidic structure of claim 1, wherein the channel and the at least one optical waveguide is comprised of poly(dimethylsiloxine).

3. The microfluidic structure of claim 1, wherein the at least one optical waveguide is further operable to optically interrogate the at least one particle.

4. The microfluidic structure of claim 1, wherein the at least one particle is selected from the group consisting of a colloidal particle, a blood cell, a tissue cell, a cell organelle, a large organic molecule, and a protein structure.

5. The microfluidic structure of claim 4, further comprising a second optical waveguide positioned substantially adjacent to the channel and operable to receive a detection signal from the at least one particle during optical interrogation.

6. The microfluidic structure of claim 1, further comprising:
an array of optical waveguides located substantially adjacent to the channel and arranged to generate optical traps within the channel; and
a plurality of particles located within the channel, wherein when individual optical waveguides within the array of optical waveguides are sequentially pulsed, thereby manipulating the plurality of particles within the channel to power a microfluidic pump.

7. The microfluidic structure of claim 1, further comprising:
an array of optical waveguides located substantially adjacent to the channel and arranged to generate optical traps within the channel; and
a plurality of particles located within the channel, wherein when the individual optical waveguides within the array of optical waveguides are sequentially pulsed, the plurality of particles are manipulated within the channel to power a microfluidic valve.

8. A microfluidic structure adapted for trapping at least one particle, comprising:
a channel operable to contain a microfluidic stream;
at least one particle located in the channel;
a diode bar laser configured to focus a laser line on the microfluidic stream and trap the at least one particle within the microfluidic stream.

9. The microfluidic structure of claim 8, wherein the at least one particle is selected from the group consisting of a colloidal particle, a blood cell, a tissue cell, a cell organelle, a large organic molecule, and a protein structure.

10. The microfluidic structure of claim 8, further comprising:
a transmission mask positioned between the microfluidic stream and the diode laser bar allowing obstruction of a laser beam from the diode bar laser.

11. The microfluidic structure of claim 8, further comprising:
a camera configured to image the microfluidic stream at a point of focus of the laser line.

12. The microfluidic structure of claim 8, wherein the microfluidic stream comprises a laminar flow of a suspension of the particles within the channel.

13. The microfluidic structure of claim 8, wherein the channel comprises a split to feed at least two outlet channels.

14. The microfluidic structure of claim 13, wherein the laser line is focused on the microfluidic stream prior to the split in the channel such that the at least one particle can be trapped within the microfluidic stream and translated to a point in the microfluidic stream that will result in laminar flow of the microparticle into any of the at least two outlet channels.

15. The microfluidic structure of claim 8, further comprising:
an excitation laser configured to induce fluorescence of the at least one particle trapped by the laser line within the microfluidic stream.

16. The microfluidic structure of claim 15, further comprising:
a camera configured to image the microfluidic stream at a point of focus of the laser line; and,
a light filter disposed between the point of focus of the laser line and the camera, wherein the filter blocks a wavelength of light from the excitation laser.

17. A method of forming a microfluidic structure adapted to provide optical interrogation of particles within the structure, comprising:
forming microfluidic channels in a poly(dimethylsiloxine) (PDMS) layer;
positioning a glass layer in contact with the PDMS layer; and
forming optical waveguides in the glass layer, the waveguides arranged in relation to the microfluidic channels to provide optical interrogation and optical trapping of particles located in the channels.

18. The method of claim 17, wherein the optical interrogation of particles located in the channels comprises inducing fluorescence in particles located in the channels.

19. The method of claim 17, wherein the waveguides are arranged to generate optical traps for particles within the microfluidic channels which, when the optical waveguides are sequentially pulsed, power a microfluidic pump.

20. The method of claim 17, wherein the waveguides are arranged to generate optical traps for particles within the microfluidic channels which, when the optical waveguides are sequentially pulsed, power a microfluidic valve.

21. The method of claim 17, further comprising interfacing the optical waveguides to a light source positioned external to the microfluidic structure.

22. The method of claim 17, further comprising the step of monitoring the forming optical waveguides step, wherein the monitoring and forming optical waveguides are performed substantially simultaneously.

23. The method of claim 22, wherein the monitoring is conducted with third harmonic generation (THG) imaging.

24. The method of claim 17, wherein the forming optical waveguides step is performed using a femtosecond laser.

25. The method of claim 24, wherein the forming step includes generating a plurality of optical waveguides substantially simultaneously.

26. The method of claim 25, wherein the forming step further includes generating a plurality of laser pulses from the femtosecond laser, wherein the plurality of laser pulses overlap spatially and are temporally decorrelated.

27. The method of claim 26, wherein the plurality of laser pulses are generated from a single laser pulse which is temporally decorrelated using a cascaded beam splitter.
